(19) United States
(12) Patent Application Publication
(10) Pub. No.: US 2007/0201432 A1
(43) Pub. Date: Aug. 30, 2007

(54) Voice gateway for multiple voice communication network

(76) Inventors: Ankur Sood, Schaumburg, IL (US); Jorge M. Alayo Espino, Chicago, IL (US); Ranjan Chatterjee, Kildeer, IL (US)

Correspondence Address: MOTOROLA, INC., 1303 EAST ALGONQUIN ROAD, IL01/3RD, SCHAUMBURG, IL, 60196, US

(21) Appl. No.: 11/363,724

(22) Filed: Feb. 28, 2006

(51) Int. Cl. H04L 12/66

(52) U.S. Cl. 370/352

(57) ABSTRACT

A method and system for providing seamless mobility. The seamless mobility system includes a computer having at least a dial up modem and an Internet access port. The dial up modem is coupled to a first telephone network and the Internet access port is coupled to a high-speed Internet access point providing Internet access. A first telephone is coupled to the first telephone network to originate a call to a second telephone. The dial up modem detects and answers the call placed by the first telephone, the call is processed by the computer, and couples the call to the high speed Internet access point for delivery of the call over the Internet. The call is coupled through the Internet to deliver the call to a second computer or coupled through the Internet to a second telephone network to deliver the call to the second telephone.

### BACKGROUND

Today there are many instant messenger software clients available (e.g. Skype, Yahoo, MSN, etc.) that allow voice communication between two personal computers.

All these instant messenger software clients use Voice over IP (VoIP) networks to transfer voice calls over the Internet from one personal computer to another. As a result, these instant messenger software clients are generally restricted for use in a home, small office or home office environment.

Today there are also many VoIP service providers that enable an individual to make telephone calls from their telephone to other telephones locally, within the United States, or anywhere in the world using the Internet with a VoIP phone/router installed at the callers home, small office or home office environment. These systems are, as a result, limited again to point-to-point communication, and do not allow the phone caller to travel while using the same phone calling convenience when out of the home, small office or home office environment.

U.S. Pat. No. 6,424,647 entitled “A Method and Apparatus for Making a Phone Call Connection over an Internet Connection” issued Feb. 2, 1999 to Ng et al., describes a method for making phone calls over the Internet. As described, the callers are required to make a regular local or international call over the Public Switched Telephone Network (PSTN), and the callers have to then end the regular call over the PSTN, and dial to their respective Internet phones to be able to talk.

### BRIEF DESCRIPTION OF THE DRAWINGS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description, like reference numerals are used to describe the same, similar or corresponding parts in the several views of the drawings.

FIG. 1 is a diagram of a seamless mobility system using voice gateways in accordance with the present invention.

FIG. 2 is a diagram of a seamless mobility system using voice gateways with messenger services or VoIP service in accordance with an embodiment of the present invention.

FIG. 3 is a diagram of a seamless mobility system using voice gateways to provide access to Enterprise VoIP networks in accordance with an embodiment of the present invention.

FIG. 4 is a diagram of seamless mobility system using voice gateways to provide local calling for travelers in accordance with an embodiment of the present invention.

FIG. 5 is a block diagram of personal computer operating as a voice gateway in accordance with several embodiments of the present invention.

FIG. 6 is a flow chart depicting the operation of a computer operating as a voice gateway in accordance with the several embodiments of the present invention.

FIG. 7 is a flow chart further depicting the operation of a computer operating as a voice gateway in accordance with the several embodiments of the present invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

The present invention enables a caller to extend calls made using VoIP networks beyond two home, small office, or home office environments to calls originated over two PSTN (public switched telephone networks), two PLMN (public land mobile networks), or any combination of the two voice communication networks with calls placed by the caller using local telephone networks.

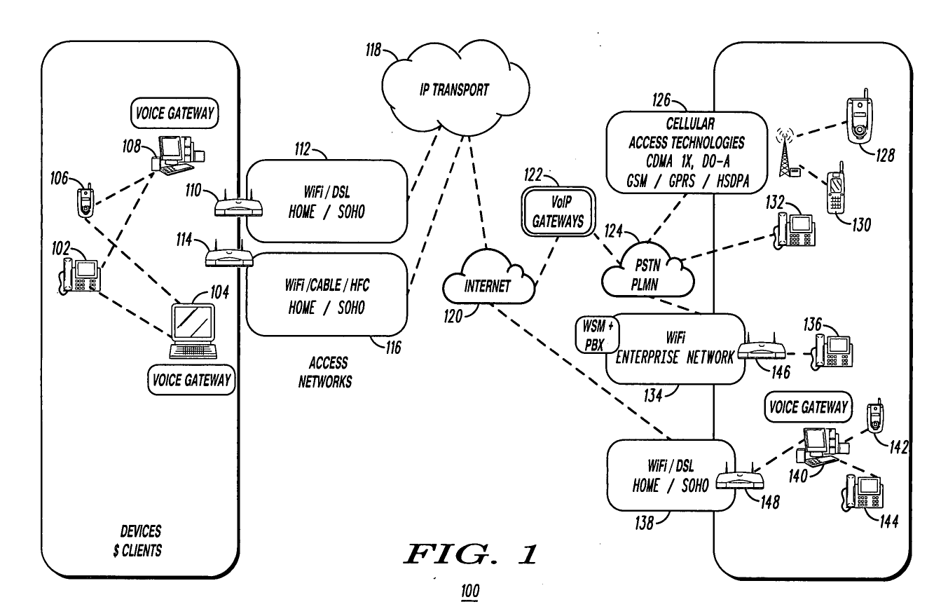

FIG. 1 is a diagram of a seamless mobility system 100 using a voice gateway in accordance with the present invention. The seamless mobility system 100 enables conventional wired or wireless telephone handsets 102 or cellular telephones 106 to place a local call through a voice gateway, such as a SoftSwitch enabled laptop computer 104 or a SoftSwitch enabled desktop computer 108. The SoftSwitch enabled laptop computer 104 or the SoftSwitch enabled desktop computer 108 operates as a voice gateway to connect local telephone calls originated over the Public Switched Telephone System (PSTN) or Public Land Mobile Radio Network (PLMN) to be sent through the Internet 120 using a wired or wireless modem, such as a DSL (digital subscriber line) modem 112 or a cable modem 116. When a DSL modem 112 is used, the DSL modem 112 couples the SoftSwitch enabled laptop computer 104 or the SoftSwitch enabled desktop computer 108 to a Network Service Provider using an Ethernet network, such as provided by a wired 10 base 10/100 Ethernet connection or a WiFi 802.11 wireless local area network (WLAN) connection providing Home/SOHO (small office/home office) capability. Likewise when used, the cable modem 116 couples the SoftSwitch enabled laptop computer 104 or the SoftSwitch enabled desktop computer 108 to the Network Service Provider using the Ethernet network, such as the wired 10 base 10/100 Ethernet connection or a WiFi 802.11 wireless local area network (WLAN) connection providing Home/SOHO (small office/home office) capability. The cable modem 116 can also provide access to a Hybrid Fiber Coaxial (HFC) network to provide access to the Network Service Provider. The Network Service Provider providing the IP transport 118 couples the call being made to the Internet 120. As described above, a DSL service provider, a conventional cable service provider, a Hybrid Fiber Coaxial network service provider, or any Internet service provider can provide the IP transport 118. The call is routed over the Internet as described above and is placed using VoIP (Voice over Internet Protocol) technology using VoIP gateways 122 provided by VoIP service providers. The VoIP gateways 122 deliver the calls through a telephone network 124, such as a Public Switched Telephone Network (PSTN) or a Public Land Mobile Radio Network (PLMN).

When delivered through the Public Land Mobile Radio Network (PLMN), the calls are delivered to cellular phones, such as cell phone 128 and cell phone 130 using a cellular telephone distribution system 126. The cellular telephone distribution systems can deliver the call using cellular system communication protocols such as CDMA (code division multiple access), DO-A, GSM (Global System for Mobile Communications), GPRS (General Packet Radio Service), and HSDPA (High-Speed Downlink Packet Access) protocols. It will be appreciated that other cellular system communication protocols can be utilized as well.

When delivered through the Public Switched Telephone Network (PSTN), the calls are delivered to wired or wireless telephone handsets 132 using conventional wired connections, or to wired and wireless telephone handsets 136 coupled to a wired or wireless Enterprise Network using a DSL modem 134 using a Web-Based System Manager (WSM) and a Private Branch Exchange (PBX).

The call can also be delivered to a Home/SOHO (small office/home office) using a DSL modem 138 or cable modem 149, that can provide wired or wireless connectivity to another SoftSwitch enabled computer 140. The call received can then be delivered to a cellular telephone 142 or a conventional wired or wireless telephone 144.

In summary, the SoftSwitch enabled computer, described above, that is located in a Home/SOHO (small office/home office) environment is used as a voice gateway to receive local calls placed by wired or wireless telephone handsets or cellular telephones over the Public Switched Telephone (PSTN) and deliver the calls through the Internet using VoIP technology. The calls can be conventionally delivered using the VoIP technology, or can be delivered using another SoftSwitch enabled computer used as a voice gateway to deliver the calls to a wired or wireless telephone handset or cellular telephone anywhere in the world. It will be appreciated that the delivery of calls described above is not limited to use in the home/SOHO (small office/home office) environment, as will be described further below.

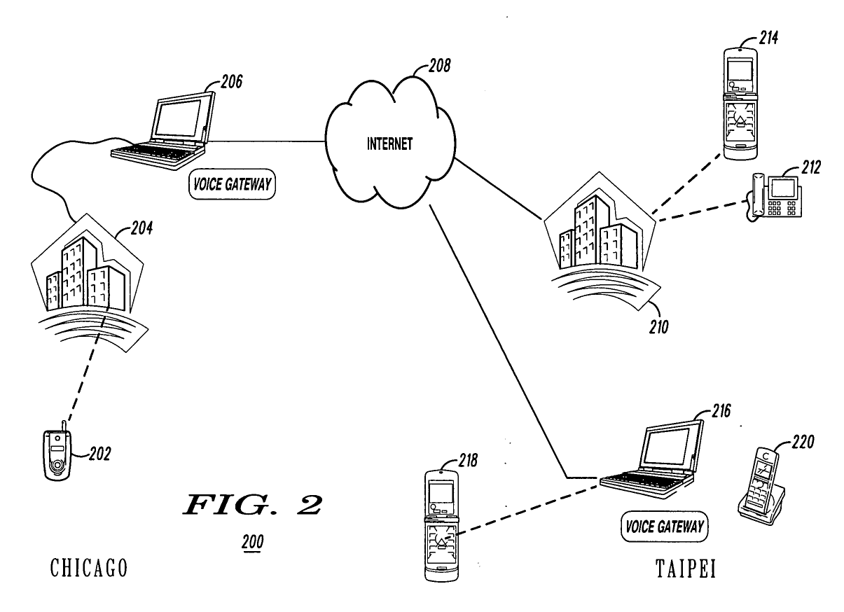

FIG. 2 is a diagram of a seamless mobility system using voice gateways to provide VoIP service in accordance with an embodiment of the present invention. Telephone calls placed through, as an example, a cellular telephone 202 can be delivered to other wired or wireless telephone handsets or cellular telephones anywhere in the world, as described above, using Internet messenger services provided by Internet Service Providers such as provided by America On Line® (AOL), Skype™, or My Yahoo®, as described above. It will be appreciated that other Internet Service Providers providing connection to VoIP Service Providers can be utilized as well.

A cellular telephone 202 can be used to place a call locally through the Public Land Mobile Radio Network to the Public Switched Telephone Network (PSTN) 204. The call is directed through the local Public Switched Telephone Network (PSTN) to a SoftSwitch enabled computer 206. The SoftSwitch enabled computer 206 forwards the call using a destination number or one of the installed “Instant Messaging” services through the Internet 208 as will be described below. The call can be delivered over the Internet 208 to a remote SoftSwitch enabled computer, such as computer 216. When the remote computer is a SoftSwitch enabled computer 216, then the call can also be delivered by the SoftSwitch enabled computer 216 to a cellular telephone 218 or a conventional wired or wireless telephone 220.

The call can also be delivered in a conventional manner through a local Public Switched Telephone Network (PSTN) 210 to a wired or wireless telephone 212, or to a cellular telephone 214 through a Public Land Mobile Network (PLMN). As illustrated in FIG. 2, the communication devices originating the call and receiving the call need not be in the same geographic area.

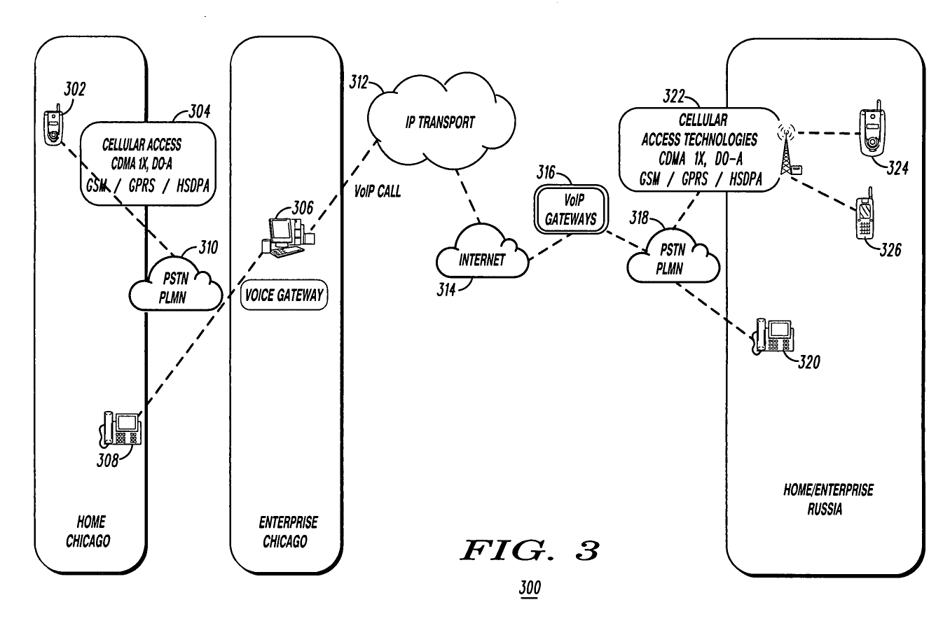

FIG. 3 is a diagram of a seamless mobility system 300 using a voice gateway to provide access to Enterprise VoIP networks in accordance with an embodiment of the present invention. There is a trend in Enterprises to move from traditional PSTN networks to VoIP networks for all phone calls. Employees can then make calls to their colleagues in the company all over the world on VoIP networks. The seamless mobility system 300 allows the employees to access their Enterprise VoIP networks to make phone calls from their home or when they are traveling. As shown in FIG. 3, when the employee is at home or traveling and wants to call a colleague, such as in Russia, the employee would normally have to use a calling card to make the call at very high rates.

An employee that is traveling and using a cellular telephone 302 can initiate a call through a cellular telephone system 304 coupled through a telephone network 310 to a SoftSwitch enabled computer 306 to access a Enterprise VoIP network in accordance with the present invention. The cellular telephone system 304 can be a Public Land Mobile Radio Network (PLMN) 304 that delivers the call using such cellular system communication protocols as CDMA (code division multiple access), DO-A, GSM (Global System for Mobile Communications), GPRS (General Packet Radio Service), and HSDPA (High-Speed Downlink Packet Access) protocols. It will be appreciated that other cellular system communication protocols can be utilized as well.

Likewise an employee can utilize conventional wired or wireless telephones 308 can originate calls to the SoftSwitch enabled computer 306 to access Enterprise VoIP networks through the telephone network 310 in accordance with the present invention. The conventional wired or wireless telephones 308 are connected through the telephone network 310, in this instance, using a Public Switched Telephone Network (PSTN).

The SoftSwitch enabled computer 306 operates as a voice gateway to connect the local calls received to be connected to the Internet 314 using a wired or wireless connection to the Enterprise's local LAN connected to the Internet. The Network Service Provider providing the IP transport 312 couples the call being made to the Internet 314. As described above, the IP transport 312 can be a DSL service provider, a conventional cable service provider, or a Hybrid Fiber Coaxial network service provider or the Enterprise's own Network. The call is routed over the Internet as described above and is placed using VoIP (Voice over Internet Protocol) technology using VoIP gateways 316 provided by VoIP service providers. The VoIP gateways 316 deliver the calls through a telephone network 318, such as a Public Switched Telephone Network (PSTN) or a Public Land Mobile Radio Network (PLMN).

When the calls are delivered through the Public Land Mobile Network (PLMN), the calls are delivered to cellular telephones, such as cellular telephone 324 or cellular telephone 326 using a cellular telephone system 322. The cellular telephone system 322 can deliver the call using such cellular system communication protocols as CDMA (code division multiple access), DO-A, GSM (Global System for Mobile Communications), GPRS (General Packet Radio Service), and HSDPA (High-Speed Downlink Packet Access) protocols. It will be appreciated that other cellular system communication protocols can be utilized as well.

When delivered through the Public Switched Telephone Network (PSTN), the calls are delivered to wired or wireless telephone handsets 320 using a conventional call routing to a wired and wireless telephone handset 320 coupled to a wired or wireless Enterprise Network 134 using a Web-Based System Manager (WSM) and a Private Branch Exchange (PBX) as described above.

Again as described above, the location of the calling telephone, and the location of the telephone receiving the call need not be in the same, or a fixed, geographic area, and can be located anywhere throughout the continental United States or throughout the World. Employees that do not have access to a SoftSwitch enabled computer, such as when calling from home or from their cellular telephone, can dial into a SoftSwitch enabled computer located at their place of business using a local phone number, and contact another party anywhere outside their immediate calling area, including calls directed to other countries.

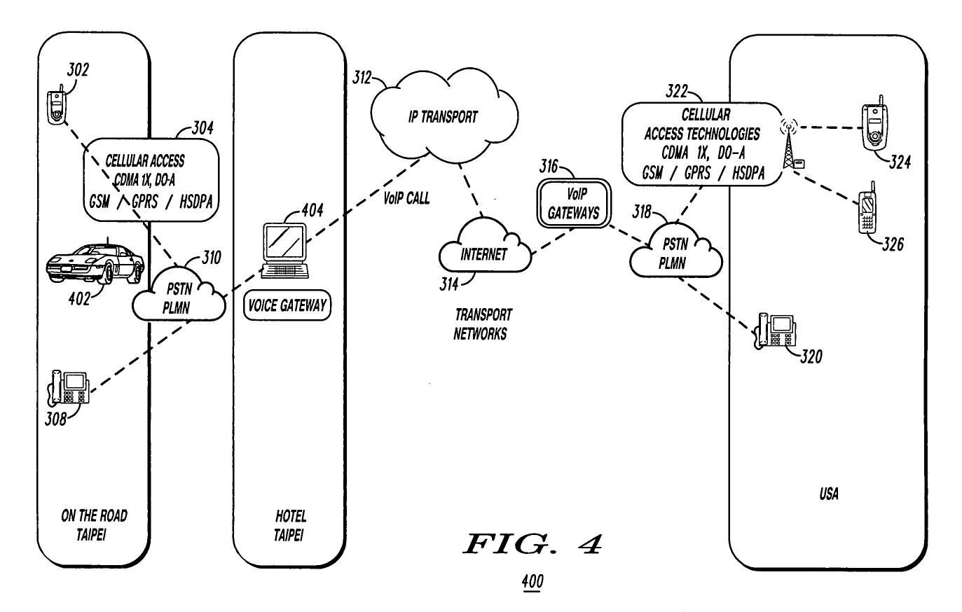

FIG. 4 is a diagram of seamless mobility system 400 utilizing a SoftSwitch enabled notebook/laptop computer 404 in accordance with the present invention to provide local calling for travelers. The operation of the seamless mobility system 400 is essentially the same as described for the seamless mobility system 300 described above. The difference lies in where a person is traveling to another geographic area, such as another country such as Taiwan, that person can enable the SoftSwitch application on their SoftSwitch enabled notebook/laptop computer 404 in a hotel room where they are staying, as an example. Now when they want to call any of their family or friends from anywhere in Taiwan, they can make a local call to/from the SoftSwitch enabled notebook/laptop computer 404 located in the hotel room, which will then route the call over the messenger, VoIP networks to the and family or friends wherever they are located.

Similarly when the person has a VoIP service, they will be able to receive all their calls through the SoftSwitch enabled notebook/laptop computer 404 located in the hotel room. However, when they are on the road, such as in a vehicle 402, they can use the SoftSwitch enabled notebook/laptop computer 404 to transfer their calls to a local number anywhere in Taiwan, thus enabling them to keep their US phone number at the same time incurring only local call rates.

When a traveler is equipped with a SoftSwitch enabled laptop computer, the traveler can place that computer at a convenient location in the area in which they are traveling, such as their hotel room or place of business locally. When they are away from their hotel room or place of business locally, they can still originate calls locally through the Public Switched Telephone Network (PSTN) or Public Land Mobile Network (PLMN) to anywhere within their local geographic area, within the country they are located or anywhere throughout the world.

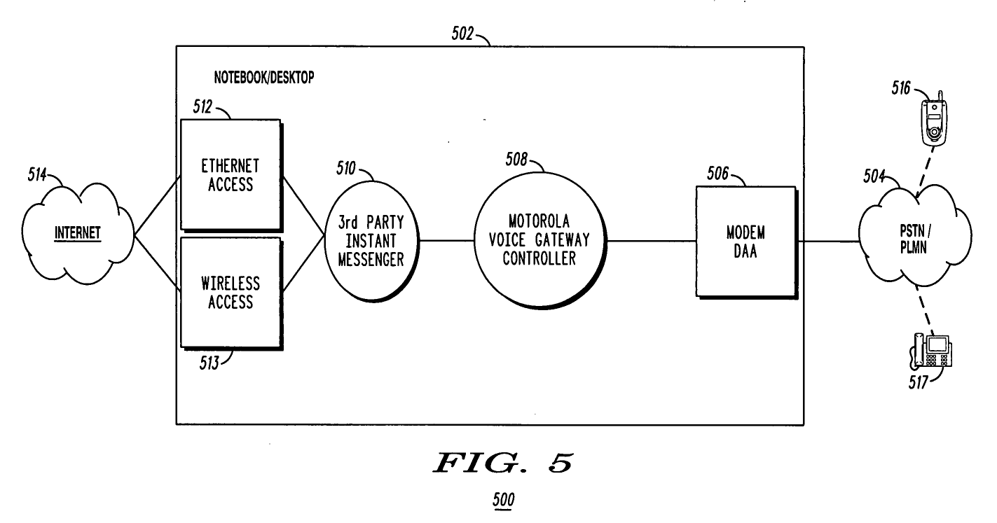

FIG. 5 is a block diagram of computer 502 operating as a voice gateway in accordance with the several embodiments of the present invention The computer 502 can be a personal computer such as a notebook/laptop computer, a desktop computer, or a server as utilized in an Enterprise to provide voice gateway functionality in accordance with the present invention. A personal computer, in addition to providing conventional computing functions can be used as a data communication device to control the switching of voice calls originating over the Public Switched Telephone Network 504 to the Internet 514 using VoIP technology. A SoftSwitch enabled computer operates as a voice gateway by switching/routing voice samples delivered through a dial-up modem input that is coupled to the Public Switched telephone Network (PSTN) to VoIP or messenger voice streams and vice-versa. The SoftSwitch enabled computer handles the call management and provides a user the ability to program numbers to forward the calls, provides the routing of phone calls to and from Messenger contacts, and to and from VoIP services. The SoftSwitch enabled computer includes security features such as authentication and authorization of remote callers. The SoftSwitch enabled computer includes a database that maps phone numbers to messenger contacts, voice recognition for voice calling, and the ability to program forwarding for specific callers only. A voice gateway controller 508 that provides DSP processing to convert voice samples to ADPCM samples provides conversion of the information. The computer 502 utilizes conventional internet access ports, such as an Ethernet access port 512 or a wireless access port 513 that enable the computer 502 to be connected to the Internet 514, using a DSL modem, cable modem or other internet access networks as described above. The computer 502 includes software providing third party instant messenger messaging routines 510, such as available from AOL, Skype, etc. also as described above. A dial-up modem 506, such as a dial-up 56K modem, enables the computer 502 to be connected to the Public Switched Telephone Network (PSTN) or Public Land Mobile Radio Network (PLMN) 504. The SoftSwitch enabled computer captures the voice samples from the instant messenger clients or other VoIP service clients and transmits them to and from the PSTN/PLMN network by utilizing the dial-up modem 506. The SoftSwitch enabled computer would also manage communication when the dial-up modem 506 will be used for typical 56K modem Dial-Up Internet access or for voice gateway PSTN/PLMN re-routing as described above.

The SoftSwitch enabled computers described above utilize the signal processing power of the microprocessors/microcomputers utilized therein to eliminate the need for an expensive dedicated digital signal processor and microcontroller for providing modem functionality. The required hardware is reduced to a modem data access arrangement (DAA) 506 having analog-to-digital and digital-to-analog sample conversion, data FIFO buffers and plug and play bus interface provided through the voice gateway controller 508. A third party Instant Messenger Service software 510 enables the voice to be sent through a VoIP service over the Internet.

Using the SoftSwitch enabled computer 500, calls originated by the user of a cellular telephone 516, or conventional telephone 517, can be routed to the local Public Switched Telephone Network (PSTN) or Public Land Mobile Radio Network (PLMN) 504, and routed to VoIP gateways using the Internet 514.

The SoftSwitch enabled computer 502 enables Messenger users having VoIP services to call messenger buddies from anywhere, without the need to be physically present on the computer as in the case of messengers, or at home for calls being placed or received over VoIP networks such as Vonage. This enables the user to be able to call from a PSTN or mobile phone into the home computer and then access the messenger buddies over the messenger VoIP service. There are existing services that allow call forwarding from VoIP or messengers to local phones but none allows the reverse way as described above.

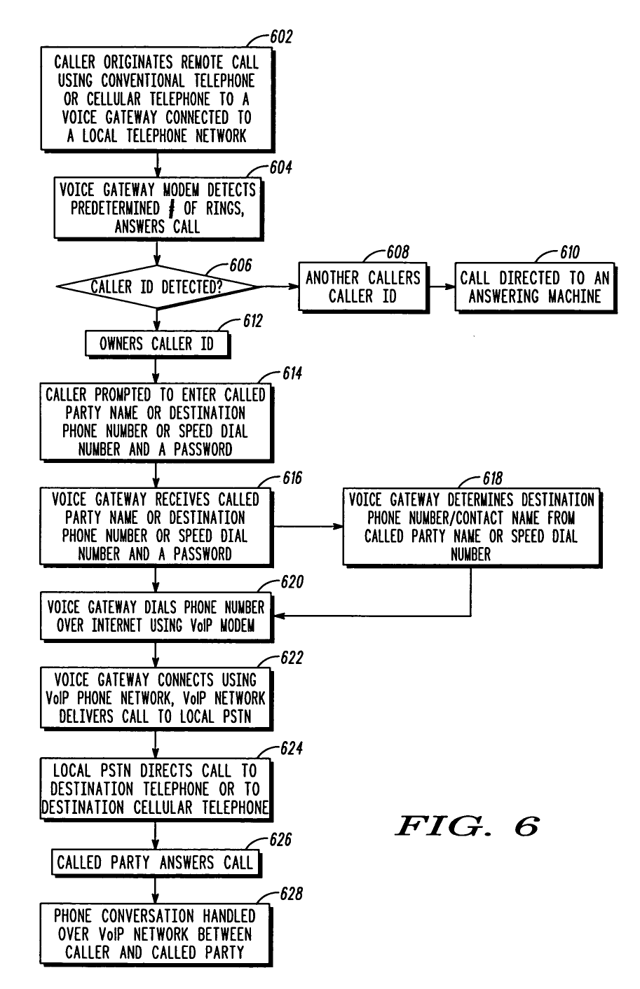

FIG. 6 is a flow chart depicting the operation of a computer such as a personal laptop or desktop computer or computer server, operating as a voice gateway in accordance with the several embodiments of the present invention. A caller originates a remote call using a conventional telephone or cellular telephone to a voice gateway that is connected through a dial-up modem to a local telephone network at 602. When the called party before a predetermined number of rings does not answer the call at 604 the voice gateway answers the call. When the call is being received at 606 caller ID of the caller is detected. When the caller ID does not match a local telephone or cellular telephone that is associated with the voice gateway, but is rather a caller ID for another caller at 608, the call is directed to an answering machine at 610. The caller can then leave a message for the called party, and when the called party interrogates the answering machine, the caller's message will be provided. When the caller ID matches a local telephone or cellular telephone that is associated with the voice gateway at 612, the caller is provided by voice prompt to enter a name of a person to which the call will be forwarded, a destination number of the person to which the call will be forwarded, or a speed dial number associated with a messenger service active on the voice gateway computer to which the call will be forwarded at 614. The caller is also requested via a voice prompt to enter a password authenticating the caller at 614. Having authenticated the caller, the voice gateway receives the name of a person to which the call will be forwarded, a destination number of the person to which the call will be forwarded, or a speed dial number associated with a messenger service active on the voice gateway computer to which the call will be forwarded at step 616. When the name of the called party or a speed dial number is received, the destination phone number or buddy contact name of the party being called is determined by the voice gateway at 618. The voice gateway determines when the called party is to be called using the VoIP phone services or instant messenger network at 620. When the called party needs to be called using the VoIP phone services, at 622, the voice gateway then dials the destination phone number received, or the destination phone number determined from the name of the called party or the speed dial number received at 618. The call is directed to VoIP servers that dial the destination phone number to be connected to the person being called via a local Public Switched telephone system (PSTN) or Public Land Mobile Radio System (PLMS) at 622. The local Public Switched telephone system (PSTN) or Public Land Mobile Radio System (PLMS) rings the party being called at 624 after which the called party answers at 626. The telephone conversation is then handled over the Internet using the VoIP network between the caller calling through the voice gateway and the called party at 628. Because a VoIP network is utilized in processing the call, the call can be directed to any person within the local calling area of the caller, or outside the local calling area of the caller including calls directed to a called party in a different country at 628.

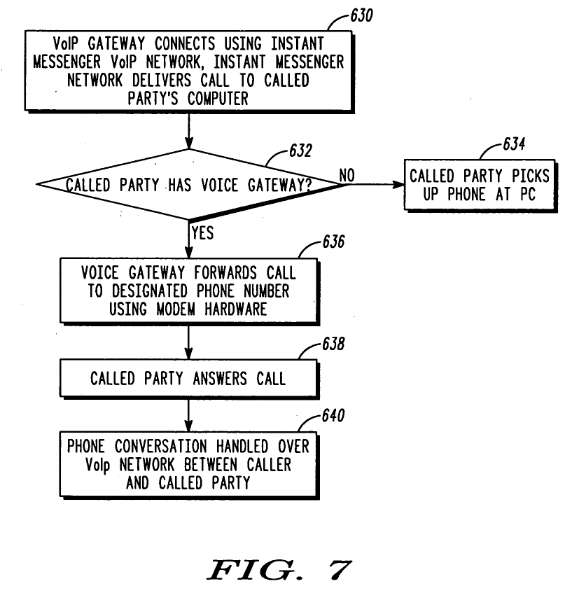

FIG. 7 is a flow chart further depicting the operation of a computer operating as a voice gateway in accordance with the several embodiments of the present invention. When the called party needs to be called using the instant messengers, at 630, the voice gateway uses the instant messenger software to call the called party determined from the name of the called party or the speed dial number received at 618. The call is directed via the instant messenger VoIP network to the called party's computer at 632. When the called party does not have access to a voice gateway at 632, the called party can answer the call at the computer at 634.

When the called party also has a voice gateway that is connected through a dial-up modem to a local telephone network and is unable to answer the call at the computer, then at 636 the voice gateway can determine to forward the call to the called party at a pre-programmed forwarding number via a local Public Switched Telephone System (PSTN) or Public Land Mobile Radio Network (PLMN). Upon answering the call at 638, a phone conversation is handled over the VoIP Network between the caller and called party at 640.

The prior art telephone systems using VoIP technology required the caller or called party to answer a telephone connected to the VoIP modem associated with the caller or called party computer. As a result when the caller or called party was not at home the caller or called party could not remotely place or receive a call. As described above, the seamless mobility system utilizing voice gateways frees the calling party and called party from being at home, office or otherwise to initiate or receive telephone calls. Because the calls are placed through a VoIP network, the cost of the calls is limited to local calling rates when placed within a country, and to significantly reduced rates when placed by a caller, or to a called party in a country different than the destination to which the call is directed.

Mobile professionals, and other people who travel, benefit when traveling as they can hook up their notebook/laptop computer to the hotel broadband line and the SoftSwitch enabled computer to the hotel telephone line. The SoftSwitch enabled computer will forward calls from their messenger buddies to any local phone in the city.

Enterprise users can benefit through significant cost savings to the enterprise.

Enterprises having a VoIP network and a SoftSwitch enabled computer installed on the employees personal computers enable the employees to call at local rates from PSTN/mobile phone into the SoftSwitch enabled computer. This allows the employees to then make VoIP calls to anywhere in the world. Thus the employees don't need to use company calling cards thereby leading to the significant cost savings for the enterprise.

While the invention has been described in conjunction with specific embodiments, it is evident that many alternatives, modifications, permutations and variations will become apparent to those of ordinary skill in the art in light of the foregoing description. Accordingly, it is intended that the present invention embraces all such alternatives, modifications and variations as fall within the scope of the appended claims.

We claim:

1. A seamless mobility system comprising:
a computer comprising at least a dial up modem and an internet access port, said dial up modem coupled to a first telephone network and said internet access port coupled to a high speed Internet access point providing Internet access;
a first telephone coupled to said first telephone network used to originate a call to a second telephone, said dial up modem detecting and answering the call, the call processed by said computer, and coupled by said computer to said high speed Internet access point for delivery of the call over the Internet;
wherein said second telephone is coupled to a second telephone network coupled to the Internet to receive the call.

2. The seamless mobility system according to claim 1 wherein said computer is a personal computer.

3. The seamless mobility system according to claim 2, wherein said personal computer is one of a portable computer and a desktop computer.

4. The seamless mobility system according to claim 1 wherein said high speed Internet access point is one of a DSL modem and a cable modem.

5. The seamless mobility system according to claim 1 wherein said computer is an Enterprise based computer.

6. The seamless mobility system according to claim 1, wherein said first telephone network is a Public Switched Telephone Network.

7. The seamless mobility system according to claim 6, wherein said first telephone is one of a wired and wireless telephone coupled to the Public Switched Telephone Network.

8. The seamless mobility system according to claim 6, wherein said first telephone network is a Public Land Mobile Radio Network coupled to said Public Switched Telephone Network.

9. The seamless mobility system according to claim 8, wherein said first telephone is a cellular telephone.

10. The seamless mobility system according to claim 1, wherein said second telephone network is a Public Switched Telephone Network.

11. The seamless mobility system according to claim 10, wherein said second telephone is one of a wired and wireless telephone coupled to the Public Switched Telephone Network.

12. The seamless mobility system according to claim 10, wherein said second telephone network is a Public Land Mobile Radio Network coupled to said Public Switched Telephone Network.

13. The seamless mobility system according to claim 12, wherein said first telephone is a cellular telephone.

14. The seamless mobility system according to claim 1, wherein said first telephone network is the same as said second telephone network.

15. The seamless mobility system according to claim 13, wherein the call is distributed over the Internet using a VoIP network.

16. A voice gateway comprising:
a computer comprising at least a dial up modem and an Internet access port, said dial up modem coupled to receive a call placed by a first telephone over a first telephone network, and said internet access port coupled to a high speed Internet access point providing Internet access to a VoIP network for delivery of the call to a second telephone network.

17. The voice gateway according to claim 16 wherein said computer further comprises a call prompter for prompting the call caller of the call received over said first telephone network to enter a destination phone number to which the call will be directed.

18. The voice gateway according to claim 17, wherein said computer further comprises a call authenticator to determine an identity of the call caller of the call received over said first telephone network.

19. The voice gateway according to claim 18, wherein said call authenticator responds to a caller ID.

20. The voice gateway according to claim 19, wherein said computer directs the call is directed to an answering machine when the call caller is not authenticated.

21. The voice gateway according to claim 19, wherein said computer directs the call to the destination phone number when the call caller is authenticated.

22. The voice gateway according to claim 19, wherein said computer requests a password before directing the call to the destination phone number.

23. The voice gateway according to claim 17, wherein the destination phone number can be a name of the called party.

24. The voice gateway according to claim 17, wherein the destination phone number can be a speed dial number.

25. A method for providing seamless mobility, comprising:
a voice gateway detecting and answering a call placed over a first telephone network that is directed to a second telephone network using a VoIP network;
the voice gateway detecting a caller ID identifying the call caller; and
the voice gateway requesting the call caller leave a message when the call caller is not authorized to send the call to the second telephone network.

26. The method for providing seamless mobility according to claim 25, further comprising:
the voice gateway requesting the call caller to enter a destination phone number associated with the second telephone network; and
the voice gateway placing the call to the second telephone network through the VoIP network.

27. The method for providing seamless mobility according to claim 26, further comprising:
the voice gateway requesting a password from the call caller;
the voice gateway the voice gateway placing the call to the second telephone network through the VoIP network when the password is correct.

28. The method of providing seamless mobility according to claim 25, wherein the call caller submits a name for the destination phone number, and further wherein the voice gateway determines the destination phone number from the name.

29. The method of providing seamless mobility according to claim 25, wherein the call caller submits a speed dial number for the destination phone number, and further wherein the voice gateway determines the destination phone number from the speed dial number.

30. The method of providing seamless mobility according to claim 26, wherein the voice gateway handles the call placed between the first telephone network and the second telephone network over the VoIP network when the call is answered by a called party on the second telephone network.
